(19) United States
(12) Patent Application Publication
(10) Pub. No.: US 2026/0246400 A1
(43) Pub. Date: Aug. 20, 2026

(54) METHOD FOR PROVIDING A COMPENSATION VARIABLE TO COMPENSATE FOR SYNCHRONISM FLUCTUATIONS FOR A MOTOR AND AUTOMATION SYSTEM COMPRISING A MOTOR

(71) Applicant: Beckhoff Automation GmbH, Verl (DE)

(72) Inventor: Andreas Kathöfer, Rietberg (DE)

(21) Appl. No.: 19/668,969

(22) Filed: May 6, 2026

Related U.S. Application Data
(63) Continuation of application No. PCT/EP2024/081746, filed on Nov. 8, 2024.

(30) Foreign Application Priority Data
Nov. 10, 2023 (DE) 10 2023 131 280.4

(51) Int. Cl. H02P 6/10; H02K 1/16; H02K 1/34; H02P 6/00; H02P 6/16

(52) U.S. Cl. CPC H02P 6/10; H02K 1/16; H02K 1/34; H02P 6/006; H02P 6/16

(57) ABSTRACT

A method is provided for generating a compensation variable to compensate for synchronism fluctuations of a motor, including the following steps: recording sensor data by a sensor unit in a first cycle time, transmitting the recorded sensor data in the first cycle time to a motor controller, transmitting the sensor data from the motor controller to a controller in a second cycle time, and processing the sensor data by the controller in the second cycle time. The controller is configured to approximate a compensation variable from the sensor data for a compensation interval, for transmitting the processed sensor data from the controller to the motor controller in the second cycle time, and for evaluating the processed sensor data to provide the compensation value from the motor controller in the first cycle time, based on current sensor data for which the compensation value can be determined in the first cycle time.

### CROSS REFERENCE TO RELATED APPLICATIONS

This application is a continuation of International Patent Application Number PCT/EP2024/081746, filed Nov. 8, 2024, entitled “Method for Providing a Compensation Variable to Compensate for Synchronism Fluctuations for a Motor and Automation System Comprising a Motor,” which claims the priority of German patent application DE 10 2023 131 280.4, filed Nov. 10, 2023, entitled “Verfahren zum optimierten Bereitstellen einer Kompensationsgröße zum Ausgleich von Gleichlaufschwankungen für einen Motor und Automatisierungssystem, umfassend einen Motor,” each of which is incorporated by reference herein, in the entirety and for all purposes.

### FIELD

The invention relates to a method for providing a compensation variable to compensate for synchronism fluctuations for a motor. Furthermore, the invention relates to an automation system comprising a motor in which a compensable synchronism fluctuation curve, in particular a compensable cogging force or a compensable cogging torque, can occur.

### BACKGROUND

Due to their design, electric motors generally exhibit a force or torque that is dependent on the position of the primary component or the rotor angle and is therefore not constant. In the following, torque in a rotary motor also implicitly refers to a force in a linear motor and vice versa. This synchronism fluctuation curve (a disturbance variable curve) has a negative effect on the control of the motor's operating variables, such as the position of the motor's moving primary or secondary component and/or the rotor's angle of rotation and/or speed or rotational speed. Furthermore, the disturbance variable curve may have a negative effect on the actual movement of the motor and, for example, lead to uneven movement; i.e., unsteady movement of the motor.

This is particularly undesirable in precision applications. Due to the disturbance variable curve, the pressure pattern becomes blurred in pressure applications, for example, and when transporting liquids, the liquid “sloshes” and vibrations are introduced into the machine, which places unnecessary strain on the mechanics, and/or the surface quality is adversely affected in machining processes, for example.

Depending on the embodiment of the electric motor, the compensation variable curve may comprise at least one magnetic cogging force or at least one magnetic cogging torque; i.e., a torque. The compensation variable curve may also include other disturbance variables that may depend on the operating mode or mechanical cogging torques or mechanical cogging forces, which are caused, for example, by bearings in the electric motors or similar, and which may also have a negative influence on the control behavior of the motor.

If the motor is embodied as a rotary motor; e.g., a synchronous motor or synchronous machine, the compensation variable curve comprises at least one torque. In other words, torque compensation or torque correction may take place.

The motor comprises a primary component and a secondary component, and if the electric motor is embodied as a linear motor, the primary component may, for example, form the so-called “rotor,” i.e., it may be embodied to be movable relative to the secondary component. However, there are also linear motors with a secondary component (rotor) that is movable relative to the primary component, in which case the following components are then reversed. If the primary component is embodied as a rotor; i.e., movable relative to the secondary component, the primary component comprises a plurality of energizable coils to generate a magnetic field for an active connection with a plurality of magnet modules of the secondary component. The magnet modules may comprise a plate on which a plurality of “permanent magnets” is arranged. The plates are available in different lengths, and a motor may comprise one or more such plates. In special cases, electromagnets (coils) may also be used in the secondary component instead of permanent magnets. The primary component is set in motion relative to the secondary component by the active connection.

Magnetic cogging torques or cogging forces arise in the linear motor due to a non-homogeneous distribution of the magnetic flux along the travel distance. Depending on the application, the travel distance of the linear motor may range from a few meters to a multiple of this, for example. In general, the maximum length of a linear motor is only limited by boundary conditions such as the “maximum cable length” of the connecting cables that may be connected to a motor controller.

Causes of the non-homogeneous distribution of the magnetic flux include:
The interruption of the stator; i.e., the coils (stator winding, i.e., the coil winding and winding teeth), which causes a change in magnetic resistance, results in a reluctance force.
The permanent magnets used for the magnetic modules of the secondary component are not all magnetized in exactly the same manner, and their dimensions vary.
The mechanical assembly of the above-mentioned permanent magnets is subject to tolerances.
The air gap; i.e., the distance between the primary and secondary components of the linear motor, varies along the travel distance.
Assembly tolerances at the joints of the individual secondary components.
Unevenness of the stator and the magnet modules; i.e., the magnet plates.

In addition to a magnetic cogging torque or magnetic cogging force, a cogging torque or cogging force from the mechanical design may also occur, which, as mentioned above, may be caused by the bearings of the linear motor, for example. The magnetic and/or mechanical cogging torque leads to unwanted and uneven “latching” of the linear motor; i.e., uneven movement, so that applications with extremely high requirements for accuracy and synchronism, such as high-precision milling machines or digital printers, may only be realized to a limited extent without compensation for the cogging torque/cogging force.

Enormous amounts of data are generated to compensate for synchronization fluctuations, especially for a linear motor. This is because the determined cogging torque or cogging force is used as a control variable for each position of the linear motor along the travel distance and is then taken into account for controlling the operating parameters of the linear motor in order to achieve uniform movement; i.e., movement with high synchronism; e.g., of the primary component of the linear motor. A movement with high synchronizing behavior may be understood as a movement suitable for high-precision applications.

The compensation variable curve along the travel distance may be determined, for example, with the aid of measurement runs in the case of a motor embodied as a linear motor. When the motor moves along the entire distance; i.e., the entire travel distance, with active position control, the cogging force curve that occurs during this run along the entire travel distance may be recorded as a compensation variable.

The enormous amount of data is due, on the one hand, to the length of the travel distance of the linear motor and, on the other hand, to the imperfect symmetry of the magnet modules of the secondary component and the air gap to the primary component and the resulting lack of periodicity.

Known methods and devices for compensating for synchronism fluctuations in a motor, such as those described in U.S. Pat. No. 9,041,336 B2, use a table in which the position-dependent curve of the compensation variable; i.e., the cogging force or cogging torque, is stored for the entire travel distance. It is understood that the amount of data required for cogging torque compensation in a rotary motor is smaller than that required for cogging force compensation in a linear motor due to the rotational symmetry of the rotary motor.

In the known method and device for compensating for synchronism fluctuations in a motor, the compensation variable curve for each position of the motor may be recorded with the aid of measurement runs; i.e., with the aid of calibration, and stored in the table. During operation of the motor, the position or rotor angle position of the motor is measured; e.g., with the aid of a sensor unit, and the compensation variable associated with the measured position or rotor angle position of the motor; i.e., cogging force or cogging torque, is read from the table and used to add a position-dependent compensation variable term to the current feedforward control for regulating the motor.

The table mentioned is often stored to compensate for synchronism fluctuations for a motor in a motor controller (embodied, for example, as a servo amplifier) that controls and/or regulates the movable primary component (or movable secondary component) of a linear motor. Control and/or regulation is carried out with a first cycle time.

A “first cycle time” is understood to be, for example, an internal cycle time with which sensor data is acquired by a sensor unit and/or a movable primary component or a movable secondary component of a motor; e.g., a linear motor, is controlled by a motor controller. The motor controller; e.g., embodied as a servo amplifier, may carry out all essential calculations with the first cycle time (e.g., every 62.5 μs). This means that the calculation cycle, comprising the reading in of the current variables (including the sensor data from the sensor unit; i.e., for example, the position or rotor angle position from the position sensor), processing the variables (i.e., processing the sensor data), and outputting the calculated variables (i.e., outputting and evaluating the processed sensor data), is completed every 62.5 μs. This first cycle is restarted every 62.5 μs. In other words, during the first cycle time, sensor data is determined as input variables, the input variables are processed into output variables, and the output variables are output.

However, the memory capacity of the motor controller is limited, so it is often not possible to completely store such a table with sufficient resolution in the motor controller. In addition, the computing capacity of the motor controller may be limited. Consequently, it is necessary to outsource the determination of the compensation variable; i.e., the cogging force or cogging torque, in order to be able to provide the compensation variable appropriate to the current actual position; e.g., of the primary component of the linear motor, for each cycle of the movable primary component. A cycle may correspond, for example, to the first cycle time mentioned above and have a value of 62.5 μs, for example.

If the determination of the compensation variable is outsourced to a controller of an automation system that communicates with the motor controller via a field bus during a second cycle time, the cogging force or cogging torque cannot simply be supplied via the field bus. This is because the second cycle time for communication via the fieldbus is typically in the range of 500 μs to 2 ms and is therefore significantly slower than the cycle of the moving primary component of the linear motor (or the moving secondary component) with the above-mentioned first cycle time. The second cycle time refers to the fieldbus communication time. The second cycle time refers to the time or cycle in which input data is provided to the controller by a motor controller via the field bus, the controller processes this input data into output data, and outputs it back to the motor controller via the field bus.

### SUMMARY

It is, therefore, the object of the present invention to provide an improved method for compensating for a synchronism fluctuation curve, in particular a magnetic cogging torque or a magnetic cogging force, for a motor, which allows for efficient use of resources and overcomes the above-mentioned disadvantages. In addition, it is the object of the invention to provide an automation system optimized for this purpose.

According to a first aspect, a method provides a compensation variable for compensating for synchronism fluctuations for a motor. The motor comprises a primary component and a secondary component, wherein, in particular, the primary component comprises a plurality of coils that are embodied to be energized in order to generate a magnetic field for an active connection with a plurality of magnet modules of the secondary component, and wherein, in particular, the primary component is set in motion relative to the secondary component by the active connection.

The method comprises the following steps:
recording sensor data by a sensor unit in a first cycle time T₁ and transmitting the recorded sensor data in the first cycle time T₁ to a motor controller in a first step,
transmitting the sensor data from the motor controller to a controller in a second cycle time T₂ in a second step, wherein the second cycle time T₂ may be set to a value different from the first cycle time T₁, in particular to a value larger than the first cycle time T₁,
processing the sensor data by the controller in a third step in the second cycle time T₂, wherein the controller is configured in the third step to approximate the compensation variable from the sensor data for a compensation interval,
transmitting the processed sensor data from the controller to the motor controller of the motor in the second cycle time T₂ in a fourth step, and
evaluating the processed sensor data to provide the compensation value from the motor controller in a fifth step in the first cycle time T₁ based on the third step and on current sensor data, for which the compensation value may be determined in the first cycle time T₁ by the motor controller.

According to a second aspect, an automation system comprises a sensor unit operatively connected to a motor controller of a motor, a motor operatively connected to the motor controller, a controller operatively connected to the motor controller or integrated into the motor controller. The sensor unit is embodied to record sensor data in a first cycle time T₁ and to transmit the recorded sensor data in the first cycle time T₁ to the motor controller, wherein the motor controller is embodied to transmit the received sensor data to the controller in a second cycle time T₂, wherein the second cycle time T₂ can be configured to have a different value from the first cycle time T₁, in particular a value larger than the first cycle time T₁.

The controller is embodied to process the sensor data, wherein processing the sensor data in the second cycle time T₂ includes approximating a compensation variable for compensating for synchronism fluctuations for the motor from the sensor data for a compensation interval, and transmitting the processed sensor data in the second cycle time T₂ to the motor controller. The motor controller is configured to evaluate the processed sensor data in the first cycle time T₁ to provide the compensation variable based on the sensor data processed by the controller in the second cycle time T₂ and current sensor data, for which the compensation variable may be determined in the first cycle time T₁ by the motor controller.

According to a third aspect, a method provides a compensation variable for compensating for synchronism fluctuations for a motor. The motor comprises a primary component and a secondary component, wherein in particular the primary component comprises a plurality of coils which are embodied to be energized in order to generate a magnetic field for an active connection with a plurality of magnet modules of the secondary component, and wherein, in particular, the primary component is set in motion relative to the secondary component by the active connection.

The method comprises the following steps:
recording sensor data by a sensor unit in a first cycle time T₁ and transmitting the recorded sensor data in the first cycle time T₁ to a motor controller in a first step, wherein the sensor data are actual positions of the primary component of the motor,
transmitting the sensor data from the motor controller to a controller in a second cycle time T₂ in a second step, wherein the second cycle time T₂ may be set to a value different from the first cycle time T₁, in particular to a value larger than the first cycle time T₁,
processing the sensor data by the controller in a third step in the second cycle time T₂, wherein the controller is configured in the third step to approximate the compensation variable from the sensor data for a compensation interval by determining coefficients of a compensation function for the compensation interval from the sensor data in the second cycle time T₂,
wherein a direction of movement of the primary component of the motor and/or a current speed of the motor may be taken into account when adjusting a width of the compensation interval, wherein a minimum width of the compensation interval corresponds to a maximum position change of the primary component with regard to the secondary component within the second cycle time T₂,
transmitting the processed sensor data from the controller to the motor controller of the motor in the second cycle time T₂ in a fourth step, and
evaluating the processed sensor data to provide the compensation value from the motor controller in a fifth step in the first cycle time T₁ based on the coefficient of the compensation function determined in the second cycle time T₂ in the third step and on current sensor data, for which the compensation value may be determined in the first cycle time T₁ by the motor controller.

### EXAMPLES

The input data (in connection with the second cycle time as field bus communication time) may comprise recorded sensor data; i.e., for example, position data of a movable primary component of a linear motor. The output data may comprise, for example, the processed sensor data; i.e., the compensation variable that has been approximated for a compensation interval from the sensor data. The second cycle time may, for example, be larger in value than the first cycle time and have a value of 2 ms, for example, so that the cycle is then restarted every 2 ms and run through completely.

The compensation variable in the linear motor may comprise a magnetic cogging force. The magnetic cogging force may be converted into a current in the motor controller; e.g., embodied as a servo amplifier, and converted into a voltage by a current controller, which may be applied to a power electronics module. It is understood that the motor controller may comprise the current controller and the power electronics module, as well as other components, which are shown schematically in FIG. 5, for example, for controlling or regulating the movable primary component of the linear motor, for example. Alternatively, it is also conceivable that the compensation variable may correspond to a current, wherein the current is converted into a voltage by the current regulator of the motor controller and thus applied to the power electronics. In a further alternative, it is conceivable that the compensation variable corresponds to a voltage applied to the power electronics of the motor controller. It is generally understood that the compensation variable may comprise any physical variable that influences the synchronous operation of the motor.

In general, the compensation interval Δx may be specified in the form [x−Δx₁, x+Δx₂], where x may specify the current sensor data; e.g., the current position of the movable primary component, and Δx₁ may indicate a first range of the compensation interval and Δx₂ may indicate a second range of the compensation interval.

As an alternative to the above-mentioned embodiment of the motor as a linear motor, the secondary component may also be embodied to be movable relative to the primary component. Furthermore, the motor may also be embodied as a rotary motor; e.g., a synchronous motor, etc. The proposed method is therefore flexible and may be used for different motor embodiments and different motors in an automation system. This allows for excellent compatibility with existing systems. In addition, resources may be optimally utilized based on the proposed method, and storage space and computing capacity; e.g., for the motor controller, may be saved compared to the controller that performs the more complex calculations, and the calculations may be cleverly outsourced or distributed.

With the aid of the proposed method and automation system, it may also be reliably ensured that calculation results are available at a defined point in time and may be processed or evaluated. The evaluation of the sensor data processed in the fifth step may be carried out instantly. It is not necessary to temporarily store newly recorded sensor data while waiting for the results from the controller. Instead, the newly recorded sensor data is processed directly by the motor controller, for example.

The amount of data generated is reduced because only a section is considered and the proposed method completely dispenses with the use of a table to correct the compensation value, as is often the case with known methods. This has the advantage of reducing the effort involved and the susceptibility to errors due to the approximation used.

In addition to a magnetic cogging force (i.e., cogging torque or torque in a rotary motor) and the alternatives mentioned above, the compensation variable may also include a mechanical cogging torque; i.e., a mechanical cogging force and/or other disturbance variables, which may thus be corrected during motor control.

Overall, this may advantageously improve the running behavior/movement behavior of the motor and improve the safety of the automation system with regard to the execution of high-precision applications.

In a further embodiment, the controller is embodied to approximate the compensation variable for a compensation interval in the third step by determining coefficients of a compensation function for the compensation interval from the sensor data in the second cycle time. The motor controller is embodied to carry out the evaluation of the processed sensor data in the fifth step based on the coefficients of the compensation function determined in the second cycle time and current sensor data in the first cycle time and to determine the compensation value from this.

As mentioned above, the output data may be the processed sensor data. In this specific case, the output data may therefore be the compensation variable, which has been approximated for a compensation interval by determining coefficients of a compensation function from the sensor data. The compensation function, including coefficients, may specify, for example, a magnetic force, or, in other alternatives, it is also conceivable that the compensation function specifies a current or a voltage, depending on the physical quantity with which the compensation variable is provided. It is understood that the invention is not limited to providing the compensation variable as a magnetic cogging force or a magnetic cogging torque, but that the compensation variable may comprise any quantity that influences the synchronous operation of the motor.

This has the advantage of allowing a reliable approximation of the compensation variable; e.g., comprising a magnetic cogging force, since the results of the outsourced approximation of the determination of coefficients of a compensation function; e.g., a polynomial function for correcting the compensation variable, with current sensor data, from which (current sensor data) corresponding values of the compensation function may be determined.

In a further embodiment, data exchange between the sensor unit and the motor controller takes place in the first cycle time, and/or energy exchange between the motor, in particular a movably embodied primary component of the motor, and the motor controller takes place in the first cycle time via at least one connecting line, which is embodied as an operational connection. Data exchange between the controller and the motor controller takes place via a first connecting line with the second cycle time. The first connecting line is embodied as a field bus. The sensor data and/or the compensation variable approximated for the compensation interval; i.e., the determined coefficients of the compensation function, form process data during data exchange via the field bus with the second cycle time, which are embedded in EtherCAT data packets, in particular if the field bus is embodied as an EtherCAT field bus.

It is conceivable to use a second connecting line between the sensor unit and the motor controller and to use a third connecting line between the motor controller and, for example, the movable primary component of the motor; e.g., the linear motor. The second connecting line may be embodied as a data line, and the third connecting line may be embodied as a motor line for transmitting energy; i.e., for supplying power to the movable primary component of the motor. Although this increases the amount of wiring required, it facilitates any maintenance work, for example, due to its transparency. Alternatively, only one connecting line between the sensor unit and the motor controller and the motor controller and the movable primary component of the motor may be used to reduce the wiring effort.

This allows for excellent compatibility with known systems and standards; e.g., the well-known EtherCAT standard. Process data (independent of the EtherCAT standard) forms control-relevant data. The first cycle time and the second cycle time are repeatable and may be embodied to have different values. For a more detailed definition of the first cycle time and the second cycle time, see page 23 ff. As a rule, the first cycle time is shorter than the second cycle time, but they may also be of equal value. In general, however, the longer cycle time is used to determine the duration of sensor data processing in the third step and to calculate the width of a compensation interval. For example, the first cycle time may be 62.5 μs and the second cycle time may be 2 ms. The aforementioned properties of the two cycle times also apply without restriction to the above explanation of the method and automation system.

In a further embodiment, a minimum width of the compensation interval may be determined from twice the maximum position change of the motor, in particular twice the maximum position change of the primary component in relation to the secondary component, within the second cycle time. The maximum position change for a motor embodied in particular as a linear motor corresponds to the maximum travel distance that may be covered along a direction of movement, in particular of the primary component of the motor, within the second cycle time.

Compliance with the minimum width of the compensation interval may advantageously reduce the amount of data generated (compared to a table, for example). Furthermore, compliance with the minimum width may ensure that the approximation of the compensation variable is always carried out by coefficients that have been determined in the range in which, for example, the movable primary component of the linear motor is currently located. In addition, the accuracy of the approximation may be advantageously improved the smaller the width of the compensation interval is selected. The maximum position change s in a linear motor may be derived from the maximum travel distance that may be covered along a direction of movement; e.g., of the primary component within the second cycle time T₂ (or, in general, the larger cycle time in terms of value). Expressed in a formula, this corresponds to:

$$s = {v}_{max} \cdot {T}_{2} ,$$

with vₘₐₓ e.g. 500 mm/s of the movable primary component of the linear motor.

Here, vₘₐₓ refers to the maximum speed at which the application of the compensation force improves run performance, not the absolute maximum speed possible for the motor. Above this speed, the superimposition of the compensation force may be ignored. The minimum width of the compensation interval Δx now corresponds to twice the maximum position change s in order to take both possible directions of movement into account and may be determined, for example, as:

$$Δ x = 2 \cdot s = 2 \cdot {v}_{max} \cdot {T}_{2} = 2 \cdot 500 mm / s \cdot 2 ms = 2 mm .$$

Referring to the above-mentioned general depiction of the compensation interval Δx in the form [x−Δx₁, x+Δx₂], in this specific example, the first range of the compensation interval Δx₁ and the second range of the compensation interval Δx₂ would each be replaced by s.

In a further embodiment, a direction of movement of the motor, in particular the primary component of the motor, and/or a current speed of the motor may be taken into account when adjusting the width of the compensation interval. If a direction of movement of the motor, in particular the primary component of the motor, and/or a current speed of the motor are taken into account when adjusting the width of the compensation interval, the minimum width of the compensation interval is halved. If the direction of movement of the movable primary component of the motor is positive, the first range of the compensation interval Δx₁=0 may be set to zero and the second range of the compensation interval Δx₂ may be set to the value s (Δx₂=s). During the standstill of the movable primary component of the motor, the first range of the compensation interval Δx₁ may be set, for example, to −s/2 (Δx₁=−s/2) and the second range of the compensation interval Δx₂ may be set, for example, to s/2 (Δx₂=s/2).

In this manner, the accuracy of the approximation may be further improved. Provided that at least the direction of movement of, for example, the movable primary component of the linear motor and/or the current speed of, for example, the movable primary component of the linear motor are taken into account when determining the width of the compensation interval, the minimum width of the compensation interval may be reduced to at least a single travel distance traveled by the movable primary component of the linear motor along the direction of movement. Without taking the direction of movement and/or the current speed into account, twice the travel distance traveled would have to be used as the minimum width of the compensation interval.

In a further embodiment, a center xₒₚₜ of the compensation interval Δx is selectable:

$${x}_{opt} = x + v \cdot ( {T}_{2} + {T}_{tot} )$$

Here, x corresponds to current sensor data of the motor, in particular to the primary component of the motor, in particular at least one current actual position of the primary component of the motor, v indicates the current speed, in particular of the primary component of the motor, T₂ corresponds to the second cycle time, and Tₜₒₜ denotes a dead time that may occur. The dead time Tₜₒₜ may occur in the system due to the arrangement of the internal processes and may be taken into account according to the above formula.

This advantageously allows for a further improvement in the accuracy of the approximation, since current data is always taken into account and the middle of the compensation interval may be selected as skillfully as possible according to the above formula. In particular, it is conceivable to use symmetrical first and second ranges or symmetrical limits for the compensation interval.

In a further embodiment, the compensation variable for controlling the motor may be taken into account as long as the current speed of the motor, in particular the primary component of the motor, is below a threshold value. The threshold value specifies, in particular, a maximum speed vₘₐₓ of the motor up to which the application of the compensation force improves the running behavior of the motor. For example, the threshold value specifies a maximum speed vₘₐₓ of the primary component of the linear motor and may vary depending on the motor used. The threshold value; i.e., the maximum speed vₘₐₓ; e.g., of the primary component of the motor, is in particular in a range of vₘₐₓ=300 to 700 mm/s, preferably vₘₐₓ=450 mm/s, and particularly preferably; e.g., for linear motors 225 of the type AL8000 from Beckhoff Automation, at vₘₐₓ=500 mm/s. Above the threshold value; i.e., the maximum speed mentioned, the magnetic cogging force has a minor influence on the movement of, for example, the linear motor since, for example, the primary component of the linear motor then moves too quickly, and the magnetic cogging force is no longer significantly “noticeable” in the mechanics.

In a further embodiment, the compensation function forms an nth-degree polynomial function, in particular a third-degree polynomial function. The coefficients of the compensation function form the coefficients of the nth degree polynomial function, in particular the coefficients of the third degree polynomial function. The degree of the polynomial function may be embodied differently for each sensor data to be processed and/or may be designed differently when repeating the first cycle time and/or the second cycle time.

This provides the advantage that simple mathematics may be used to approximate the compensation function, which is used as the basis for correcting the compensation variable. The degree of the polynomial function is also flexibly adjustable (varying for the individual calculation cycles or different for individual data or different for each calculation of a cycle, etc.), which allows for the best possible approximation results and optimizes accuracy. The use of simple mathematics allows for the provision of a reliable and robust method or automation system that uses the proposed method.

In a further embodiment, the motor is embodied as a linear motor, and the compensation variable comprises at least one magnetic cogging force. The linear motor comprises the movably embodied primary component and the secondary component with the plurality of magnet modules. The primary component comprises a plurality of stator segments, each of which has a plurality of energizable coils. A stator segment defines a pole pitch; i.e., a period with which a polarity of the plurality of magnetic modules of the secondary component repeats. The minimum width of the compensation interval is smaller than the pole pitch.

If the minimum width of the compensation interval is smaller than the pole spacing; e.g., 1/10 of the pole spacing with a pole spacing of 24 mm, then approximation is advantageously improved in terms of accuracy and reliability.

Overall, an improvement in driving behavior; i.e., the movement behavior of the motor, may be achieved, and the safety of the automation system in terms of the execution of high-precision applications may be improved.

In a further embodiment, the motor is embodied as a rotary motor, and the compensation variable comprises at least one magnetic cogging torque. The magnetic cogging torque may form a magnetic cogging torque. Advantageously, the proposed method or automation system is not limited to a specific embodiment of a motor or automation system with a specific embodiment of a motor but may be used flexibly in combination with different types of motors. This advantageously improves compatibility with existing systems and standards. In addition to a magnetic cogging force (magnetic cogging torque in a rotary motor) and the above-mentioned alternatives, the compensation variable may also include a mechanical cogging torque/cogging force and/or other disturbance variables, which may thus be corrected during the control of the motor.

In a further embodiment, the evaluation of the processed sensor data in the fifth step comprises applying the compensation variable to a control of the motor, in particular the movably embodied primary component of the motor, by the motor controller.

The compensation variable may be determined independently of the actual control of the movable primary component of the motor and may be combined with the actual control; i.e., superimposed; i.e., added, so that an approximately uniform; i.e., smooth movement of the movable primary component of the motor may be achieved in the overall result.

In a further embodiment, the sensor data received in the first step comprises position data of the motor, in particular along a distance traveled by the motor, provided that the motor is embodied as a linear motor. Alternatively, the sensor data received in the first step may comprise rotational angle data of the motor, provided that the motor is embodied as a rotary motor.

The proposed method and automation system may be used flexibly for different types of motors. The sensor data is recorded via a sensor unit. This may be embodied, for example, as a position sensor or as a rotation angle sensor.

In a further embodiment, the method may be used to calibrate the motor. The compensation variable curve along the travel distance may be determined, for example, with the aid of measurement runs in the case of a motor embodied as a linear motor. When the motor moves along the entire distance; i.e., the entire travel distance, with active position control, the force curve that occurs during this run along the entire travel distance may be recorded as a compensation variable. The calibration of the motor may be repeated as desired, in particular under different boundary conditions, and the proposed method may be applied for this purpose. This provides the basis for a wide range of applications and enables simple implementation. If measurement runs have been carried out under different boundary conditions, the disturbance variable curve that best matches the boundary conditions present during operation may be used for compensation.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic depiction of a method for providing a compensation variable for a motor.

FIG. 2 shows a schematic depiction of an automation system comprising a motor in which the application of a compensation variable is useful and a design-related synchronism fluctuation curve (a disturbance variable curve) may occur.

FIG. 3 shows a more detailed schematic depiction of components of the motor in FIG. 2.

FIG. 4 shows a schematic depiction of a curve of a compensation variable, which comprises, for example, a magnetic cogging force.

FIG. 5 shows an example of the method in FIG. 1 for the automation system in FIG. 2 and its components in FIG. 3.

It should be noted that the figures are only schematic in nature and are not to scale. In this sense, components and elements shown in the figures may be exaggeratedly large or small for better understanding. Furthermore, it should be noted that the reference symbols in the figures have been chosen to be unchanged or similar when they refer to elements and/or components of the same or similar embodiment.

### DETAILED DESCRIPTION

In the following, the terms “synchronism fluctuation curve,” “disturbance variable curve,” and “compensation variable curve” may be understood as synonyms.

The terms “compensation” and “to compensate” may also be understood to mean “correction” and “to correct.”

The terms “position” and “actual position” may be understood as synonyms.

“Movable primary component” or “movable secondary component” of a motor; e.g., a linear motor, may also be understood as “rotor.”

A “compensation variable” may generally be understood as synchronism fluctuations in a motor that need to be compensated for. Depending on the embodiment of the motor; e.g., as a linear motor or a rotary motor (e.g., synchronous machine or motor), the compensation variable may comprise at least one “magnetic cogging force” and/or one “mechanical cogging force” (e.g., linear motor) and/or a “magnetic cogging torque” (e.g., rotary motor) and/or “other disturbance variables” that may be compensated; i.e., corrected, for motor control and may be applied additively to the motor control, for example.

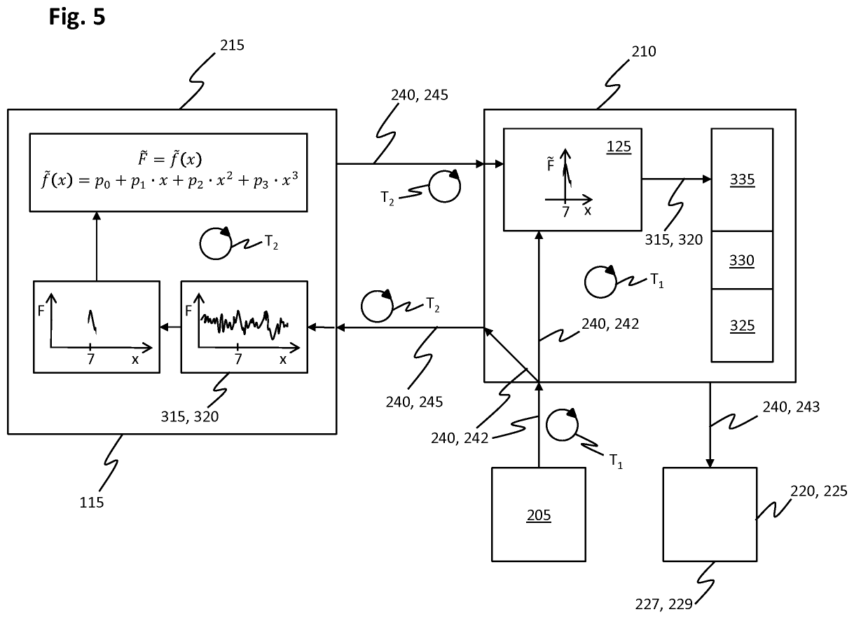

The compensation variable, which is embodied as a magnetic cogging force, for example, may be converted into a current in the motor controller and converted into a voltage by a current controller, which may be applied to a power electronics module. It goes without saying that the motor controller may comprise the current controller and the power electronics module, as well as other components, which are shown schematically in FIG. 5, for example, for controlling or regulating the movable primary component of the linear motor, for example. Alternatively, it is also conceivable that the compensation variable may correspond to a current, wherein the current is converted into a voltage by the current regulator of the motor controller and thus applied to the power electronics. In a further alternative, it is conceivable that the compensation variable corresponds to a voltage applied to the power electronics of the motor controller. It generally goes without saying that the compensation variable may comprise any physical variable that influences the synchronous operation of the motor.

A “first cycle time” is understood to be, for example, an internal cycle time with the aid of which sensor data is recorded by a sensor unit and/or a movable primary component or a movable secondary component of a motor; e.g., a linear motor, is controlled by a motor controller. The motor controller; e.g., embodied as a servo amplifier, may carry out all essential calculations with the first cycle time T₁ (e.g., every 62.5 μs). This means that the calculation cycle, comprising the reading in of the current data (including the sensor data from the sensor unit; i.e., for example, the position or rotor angle position from the position sensor), the processing of the data (i.e., processing of the sensor data, for example, preprocessing of the recorded sensor data for transmission to the controller, etc.), and outputting the calculated variables (i.e., outputting and evaluating the processed sensor data), is completed every 62.5 μs. This cycle is restarted every 62.5 μs.

In other words, in the first cycle time T₁, sensor data is determined as input data, the input data is processed into output data, and the output data is output. The output data may be currently processed sensor data; i.e., the compensation variable that is approximated for a compensation interval from the current sensor data, and/or preprocessed sensor data that is transmitted to the controller to approximate the compensation variable.

A “second cycle time” is understood to be a field bus communication time. The second cycle time T₂ refers to the time or cycle in which input data is provided to a controller by a motor controller via the field bus, the controller processes this input data into output data, and outputs it back to the motor controller via the field bus. The input data may be recorded sensor data; e.g., position data of a movable primary component of a linear motor. The output data may be, for example, the processed sensor data; i.e., the compensation variable that has been approximated for a compensation interval from the sensor data. The second cycle time may, for example, be larger in value than the first cycle time and have a value of 2 ms, for example, so that the cycle is then restarted every 2 ms and run through completely.

A “motor controller” is understood to be, for example, a “servo amplifier” or an alternative unit for drive control. The “motor controller” is configured to implement control commands from a “controller” and/or to generate electrical control signals for a movable primary component of the motor or for a movable secondary component of the motor. The motor controller may be embodied as a “subordinate device,” i.e., a (hierarchically) subordinate network subscriber in an automation system or network, which is controlled by a “main device,” i.e., a control network subscriber.

A “controller” is understood to be a “MainDevice”; i.e. a control network subscriber for controlling a “SubordinateDevice”; i.e. a hierarchically subordinate network subscriber, wherein the “MainDevice” and “SubordinateDevice” communicate with each other via a field bus. The “controller” may be, for example, a control PC or an industrial PC.

The term “pole pitch” refers to a period with which the polarity of a plurality of magnetic modules of the (fixed) secondary component repeats itself.

A “magnetic module” or “multiple magnetic modules” refers to a permanent magnet or an arrangement of multiple permanent magnets, which are arranged, for example, along a travel path, provided that the motor is embodied as a linear motor. The magnetic modules may comprise a plate on which multiple permanent magnets are arranged. The plates are available in different lengths, and a motor may comprise one or more such plates. In special cases, electromagnets (coils) may also be used in the secondary component instead of permanent magnets.

The term “air gap” refers to the distance between the primary and secondary components of the motor, which is embodied as a linear motor, for example.

The term “active connection” refers to a magnetic coupling between the primary and secondary components of the motor.

“Sensor data” may be understood to mean a single piece of sensor data; e.g., position data or actual position data; e.g., of a movable primary component of an engine, which has been recorded by a sensor unit in the above-mentioned first cycle time. It is understood that current sensor data may refer to current sensor data. Alternatively, the sensor unit may be configured to capture multiple sensor data in the first cycle time with the sensor unit (or current sensor data may therefore refer to multiple current sensor data).

An “operational connection” may form a communicative connection, in particular if the connection line is embodied as an operational connection; e.g., in the form of a data line or a field bus.

The proposed method for optimally providing a compensation variable to compensate for synchronism fluctuations for a motor, as well as the proposed automation system, is based on the idea of outsourcing computationally and memory-intensive components that are necessary for providing the compensation variable to suitable components outside a motor controller that is used for the actual drive control of the motor and to combine the memory- and computation-intensive components with the less computation-intensive components that the motor controller may process itself, for example, in order to obtain the best possible compensation result. In addition, by cleverly choosing a compensation interval for providing the compensation variable, the amount of data to be processed may be advantageously reduced and the accuracy of the approximation improved.

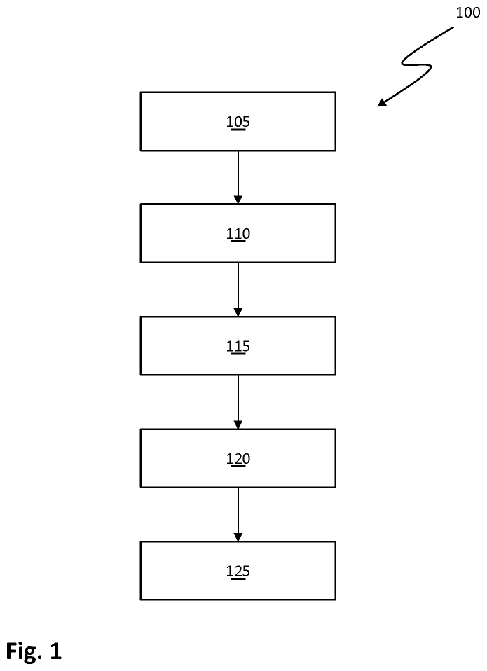

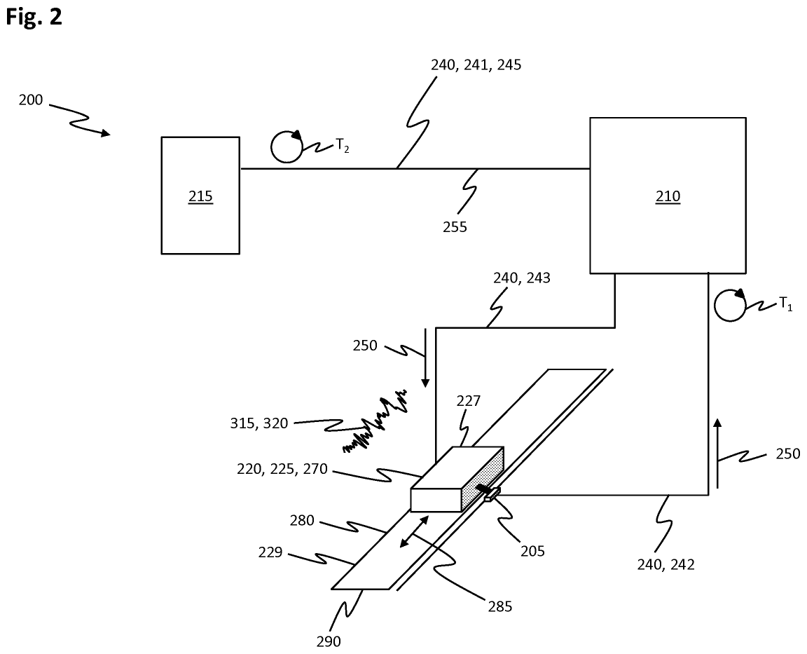

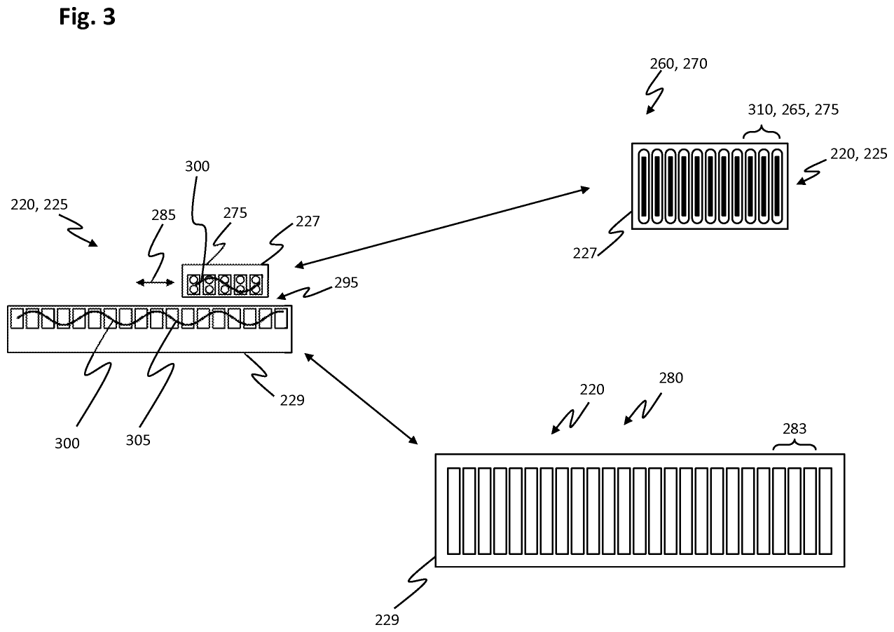

FIGS. 1 to 3 are described in combination in the following. FIG. 1 shows a schematic depiction of a method 100 for providing a compensation variable to compensate for synchronism fluctuations for a motor. FIG. 2 shows a schematic depiction of an automation system 200 comprising an electric motor 220 in which a disturbance variable curve may occur, and FIG. 3 shows a more detailed schematic depiction of components of the motor 220 in FIG. 2. The electric motor 220 is preferably embodied as a linear motor 225.

The electric motor 220 embodied as a linear motor 225 comprises a primary component 227 and a secondary component 229. Preferably, the primary component 227 of the linear motor 225 is embodied to be movable 285 relative to the secondary component 229 of the linear motor 225, as shown in FIG. 2 with the arrow illustrating the movability 285. Alternatively, however, the secondary component 229 may also be movable 285 relative to the primary component 227. If the primary component 227 is movable 285 relative to the secondary component 229, the primary component 227 comprises a plurality of coils 270 that are embodied to be energized in order to generate a magnetic field for an active connection with a plurality of magnet modules 280 of the secondary component 229. The plurality of magnet modules 280 of the secondary component 229 may be arranged along a travel path 290 of the linear motor 225.

Depending on the application, the travel distance 290 of the linear motor may comprise a total length of a few meters up to a multiple thereof. It goes without saying that different lengths; i.e., shorter or longer, are possible as well. The primary component 227 is set in motion relative to the secondary component 229 by the active connection 305. It goes without saying that if the secondary component 229 of the linear motor 225 is embodied to be movable 285 relative to the primary component 227, the arrangement of the aforementioned components is then reversed.

FIG. 3 shows the primary component 227 and the secondary component 229 of the linear motor 225 in more detail. The movable 285 primary component 227 comprises a plurality of stator segments 260, each of which comprises a plurality of energizable coils 270 (with copper windings or stator windings comprising copper). A first stator segment 260, for example, comprises three coils 275 and defines a pole pitch 310; i.e., a period by which a polarity of the plurality of magnet modules 280 of the secondary component 229 is repeated. The pole pitch 310 is shown as an example on the primary component 227 of the linear motor 225 in FIG. 3 and is typically 24 mm for a linear motor of type AL8000 from Beckhoff Automation GmbH. It goes without saying that the pole pitch 310 may be different when using a different linear motor 225 and that the invention is not limited to the example mentioned.

When the coils 275 are energized, a traveling magnetic field 300 is generated in the primary component 227 of the linear motor 225, which passes through the coils 275 (the electromagnets) themselves as well as the magnet modules 280; i.e., the permanent magnets of the secondary component 229. Above, this has been referred to as the active connection 305. As an example, a first magnet module 283 is shown in FIG. 3 to delineate the plurality of magnet modules 280. It goes without saying that the position of the first magnet module 283 has been chosen arbitrarily and does not represent any limitation. As a result of the active connection 305; i.e., the magnetic coupling, a force acts on the primary component 227. The primary component 227 reacts and follows the movement of the magnetic field; i.e., the magnetic field 300, wherein the primary component 227 is moved 285 relative to the secondary component 229.

The automation system 200 in FIG. 2 further comprises a sensor unit 205 that is operatively connected to a motor controller 210 of the electric motor 220 embodied as a linear motor 225. The electric motor 220 embodied as a linear motor 225 is operatively connected to the motor controller 210. The motor controller 210 may, for example, be embodied as a servo amplifier in accordance with the above definition.

The sensor unit 205 is configured to record sensor data in a first cycle time T₁ and to transmit the recorded sensor data in the first cycle time T₁ to the motor controller 210. The first cycle time T₁ may, for example, have a value of 62.5 μs. It goes without saying that the first cycle time T₁ could also have a different value.

The automation system 200 further comprises a controller 215 that is operatively connected to the motor controller 210. Alternatively, the controller 215 could also be integrated into the motor controller 210. The motor controller 210 is embodied to transmit the received sensor data to the controller 215 in a second cycle time T₂, wherein the second cycle time T₂ may be embodied to have a different value from the first cycle time T₁, in particular a value larger than the first cycle time T₁. For example, the value of the second cycle time T₂ is 2 ms. In other words, the second cycle time T₂ is significantly slower than the first cycle time T₁. The controller 215 may, for example, be embodied as a control PC or industrial PC or a comparable unit that is embodied to process the sensor data.

It is conceivable that the controller 215 is embodied as MainDevice; i.e., as a control network subscriber, and the motor controller 210 is embodied as a SubordinateDevice; i.e., as a hierarchically subordinate network subscriber that may be controlled by the main device.

The sensor data recorded by the sensor unit 205 includes, for example, position data of the motor 200; i.e., position data of the movable primary component 227 of the motor 220 along the travel distance 290 of the primary component 227 of the motor 220, provided that the motor 220 is embodied as a linear motor 225. The sensor unit 205 may therefore be embodied as a position sensor unit or at least comprise a position sensor element.

If, on the other hand, the motor 220 is embodied as a rotary motor, the sensor data comprises angle data (rotor rotation angle data) of the rotary motor; i.e., its movable primary or secondary component. The sensor unit 205 may therefore be embodied as a rotation angle sensor unit or a rotation angle sensor element for detecting rotor rotation angle data.

The operational connection between sensor unit 205 and motor controller 210 and/or the operational connection between motor 220, linear motor 225; e.g., the movable 285 primary component 227 of linear motor 225, and motor controller 210 is embodied as at least one connecting line 240. A connecting line 240 may comprise a first connecting line 241, a second connecting line 242, and a third connecting line 243.

In the example shown in FIG. 2, the first connecting line 241 is arranged between the controller 215 and the motor controller 210 as an operational connection. The first connecting line 241 is embodied as a data line; i.e., as a field bus 245, and in this case, for example, as an EtherCAT field bus. The second connecting line 242 is arranged between the motor controller 210 and the sensor unit 205, and the third connecting line 243 is arranged between the movable primary component 227 of the linear motor 225 and the motor controller 210. The first connecting line 241 as a field bus 245 may be embodied, for example, as a network wire. The second connecting line 242 between the motor controller 210 and the sensor unit 205 may also form a data line with parallel interfaces (or serial interfaces).

The third connecting line 243 between the movable primary component 227 of the linear motor 225 and the motor controller 210 is embodied as a motor line; i.e., it is embodied to transmit energy. The primary component 227 is supplied with power via the third connecting line 243. Alternatively, it is conceivable to configure the second connecting line 242 and the third connecting line 243 as a common connecting line (for example, as OCT: One Cable Technology from Beckhoff Automation) in order to further reduce the cabling effort.

Data exchange between the sensor unit 205 and the motor controller 210 via the second connecting line 242; i.e., the data line with parallel or serial interfaces, and/or energy exchange between the movable primary component 227 of the linear motor 225 and the motor controller 210 via the third connecting line 243; i.e., the motor line, takes place in each case with the first cycle time T₁. Data exchange between the sensor unit 205 and the motor controller 210 via the second connecting line 242; i.e., the data line with parallel or serial interfaces, and/or energy exchange between the movable primary component 227 of the linear motor 225 and the motor controller 210 via the third connecting line 243; i.e., the motor line, takes place in each case with the first cycle time T₁.

Data exchange between the sensor unit 205 and the motor controller 210 via the second connecting line 242; i.e., the data line with parallel or serial interfaces, and/or energy exchange between the movable primary component 227 of the linear motor 225 and the motor controller 210 via the third connecting line 243; i.e., the motor line, takes place in each case with the first cycle time T₁. Data exchange between the controller 215 and the motor controller 210 via the first data line 241, which is embodied as a field bus 245, takes place with the second cycle time T₂. The first cycle time T₁ and second cycle time T₂ may have the values mentioned above. The exchanged data or the sensor data may each form process data; i.e., control-relevant data, which, if the field bus 245 is embodied as an EtherCAT field bus, is embedded in EtherCAT data packets.

Data exchange via the field bus 245 may, for example, be bidirectional 255, while data exchange via the second data line 242 may be unidirectional.

If the motor 220 is embodied as a linear motor 225, the compensation variable 315 comprises at least one magnetic cogging force 320. If, on the other hand, the motor 220 is embodied as a rotary motor; e.g., a synchronous motor or machine, the compensation variable 315 comprises at least one magnetic cogging torque. The magnetic cogging torque may form a magnetic cogging torque.

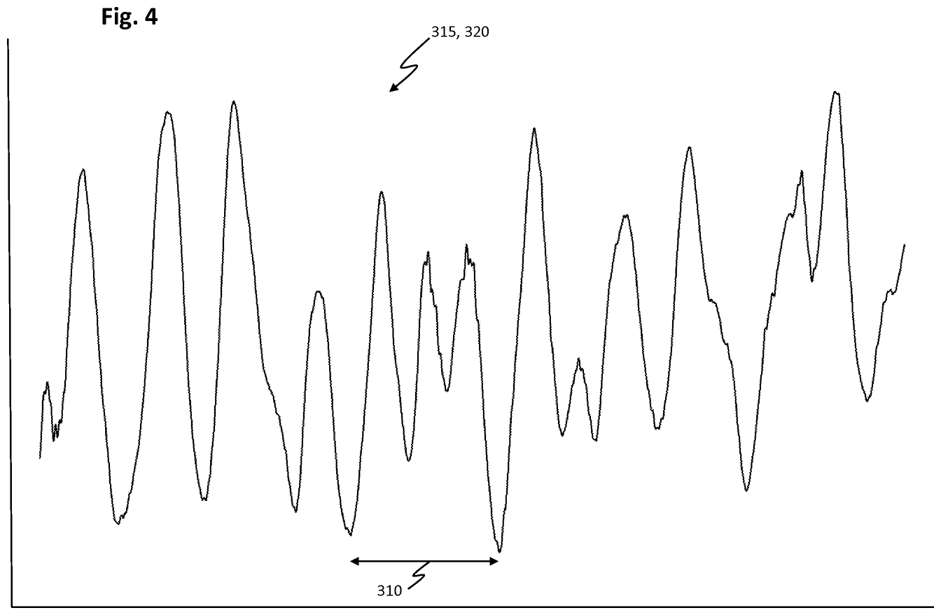

The compensation variable 315 may be embodied as described above and comprise at least one magnetic cogging force 320. This is shown schematically in FIG. 2. A more detailed depiction of an exemplary curve of the compensation variable 315; e.g., the magnetic cogging force 320, is shown in FIG. 4 and will be described later.

A magnetic cogging force 320 arises, for example, in an electric motor 220 embodied as a linear motor 225 due to a non-homogeneous distribution of the magnetic field 300 (or the magnetic flux) along the travel distance 290. Causes of the non-homogeneous distribution of the magnetic field 300 or the magnetic flux include the following:
The interruption of the stator; i.e., the majority of coils 270 (stator winding; i.e., the coil winding and winding teeth), which causes a change in magnetic resistance, results in a reluctance force.
The permanent magnets used for the magnetic modules 280 of the secondary component 229 are not all magnetized in exactly the same manner, and their dimensions vary.
The mechanical assembly of the above-mentioned permanent magnets is subject to tolerances.
The air gap 295; i.e. the distance between the primary component 227 and secondary component 229 of the linear motor 225 varies along the travel distance 290.
Assembly tolerances at the joints of the individual secondary components 229
Unevenness of the stator and the magnet modules 280; i.e., the magnet plates.

Enormous amounts of data are generated to correct the magnetic cogging force 320 (compensation variable 315) that occurs, especially for a linear motor 225. This is because the corresponding magnetic cogging force is determined as a pilot variable for each position of the movable primary component 227 of the linear motor 225 along the travel distance 290. The cogging force 320 is taken into account as a pilot variable for controlling the operating parameters of the linear motor 225; e.g., current supply, etc.; e.g., as an additive variable applied to the controller in order to achieve uniform, homogeneous movement; e.g., of the primary component 227 of the linear motor 225. This results in a position-dependent curve of the cogging force 320 over the travel distance 290 or, in the case of a rotary motor, an angle-dependent curve of the magnetic cogging torque.

It goes without saying that the amount of data for the curve of the magnetic cogging force 320 scales with the length of the travel distance 290 of the movable primary component 227 of the linear motor 225. In addition, the non-perfectly symmetrical embodiment of the magnet modules 280 of the secondary component 229 and the air gap 295 between the primary component 227 and the secondary component 229 of the linear motor 225, which does not allow for repeatability of the data, contributes to the high amount of data. As a rule, the position-dependent curve of the magnetic cogging force 320 in a linear motor 225 is stored in the form of a table. It is also conceivable to record the position-dependent curve of the magnetic cogging force 320 in the course of a measurement run, in the broadest sense of a calibration of the motor 220 or the linear motor 225, which may be repeated several times.

When using the above-mentioned automation system 200, comprising a linear motor 225, a controller 215, a sensor unit 205, and a motor controller 210, the computing power and storage capacity of the controller 215 are generally better; i.e., larger than that of the motor controller 210. To store a table of the magnetic cogging force 320 in a memory unit of the motor controller 210 and/or for determining the complete curve of the magnetic cogging force 320 over the entire travel distance 290 of the linear motor 225 by the motor controller 210, the capacity of the motor controller 210 is not sufficient.

However, the communication time; i.e., the second cycle time T₂ with, for example, 2 ms between the controller 215 (with the better computing power and memory capacity) and the motor controller 210, is significantly larger or longer than the first cycle time T₁; e.g., 62.5 μs, during which the sensor data; i.e., position data for cogging force compensation, is recorded by the sensor unit 205 and transmitted to the motor controller 210. It is therefore necessary to carry out or outsource the calculation or determination of the magnetic cogging force 320 in a clever way, which is done by the proposed method 100—without using a table for the position-dependent curve of the magnetic cogging force 320.

The following method 100 is described with reference to the correction of a magnetic cogging force 320 as a compensation variable 315 for a linear motor 225 of an automation system 200. However, it goes without saying that method 100 is not limited to the correction of a magnetic cogging force 320 and a linear motor 225 but may also be used, for example, for mechanical cogging torque correction and/or cogging torque correction of a rotary motor.

The method 100 comprises, in a first step 105, recording sensor data with the aid of a sensor unit 205 and transmitting the recorded sensor data (all within the first cycle time T₁) to the motor controller 210 of the linear motor 225, as shown in FIG. 1. The first cycle time T₁ comprises, for example, the above-mentioned value T₁=62.5 μs. A second step 110 of the method 100 comprises transmitting the sensor data from the motor controller 210 to the controller 215 in the second cycle time T₂, wherein the second cycle time T₂ may have the above-mentioned value, T₂=2 ms. The two cycle times; i.e., the first cycle time T₁ and the second cycle time T₂, could alternatively also comprise other values, in which case the larger of the two cycle times is decisive for the calculation.

A third step 115 of the method 100 comprises processing the sensor data with the aid of the controller 215 during the second cycle time T₂. In the third step 115, the controller 215 is embodied to approximate the magnetic cogging force 320 as a compensation variable 315 for a compensation interval in the second cycle time T₂ from the sensor data. The approximation of the magnetic cogging force 320 in the third step 115 is carried out by determining coefficients of a compensation function for the compensation interval. The compensation interval thus specifies a width of a data section of the position-dependent curve of the magnetic cogging force 320 to be considered for compensation.

A minimum width of the compensation interval may be determined, for example, from twice the maximum position change of the movable primary component 227 of the linear motor 225 within the second cycle time T₂. The maximum position change for a linear motor 225 corresponds to the maximum travel distance 290 that may be covered along the travel distance 290; e.g., of the primary component 227 of the linear motor 225, within the second cycle time T₂. Expressed as a formula, the maximum position change s; e.g., of the movably designed primary component 227, in the second cycle time T₂ is:

$$s = {v}_{max} \cdot {T}_{2} ,$$

where vₘₐₓ denotes the maximum speed of the movable primary component 227 of the linear motor 225 up to which the application of the compensation force improves the running behavior of the motor 220; e.g., the linear motor 225 and does not correspond to the absolute maximum speed possible for the motor.

The minimum width of the compensation interval Δx now corresponds to twice the maximum position change s in order to take into account both possible directions of movement of the primary component 227 of the linear motor 225 and may thus be calculated as follows:

$$Δ x = 2 \cdot s = 2 \cdot {v}_{max} \cdot {T}_{2} = 2 \cdot 500 mm / s \cdot 2 ms = 2 mm ,$$

with vₘₐₓ e.g. 500 mm/s. In general, the smaller the compensation interval Δx may be selected, the higher the accuracy of the approximation of the magnetic cogging force 320 and, thus, the correction of the magnetic cogging force 320.

In general, the compensation interval Δx may be specified in the form [x−Δx₁, x+Δx₂], wherein x may specify the current sensor data; e.g., the current position of the movable primary component 227, and Δx₁ may indicate a first range of the compensation interval and Δx₂ may indicate a second range of the compensation interval. Referring to the general depiction of the compensation interval Δx in the form [x−Δx₁, x+Δx₂], in this specific example, the first range of the compensation interval Δx₁ and the second range of the compensation interval Δx₂ would each be replaced by s.

The above-mentioned minimum width of the compensation interval Δx is the minimum width of the data section to be considered of the position-dependent curve of the compensation variable; e.g., the magnetic cogging force for a direction of movement of the movable primary component 227 of the linear motor 225. If the width of the compensation interval Δx is selected to be equal to the above-mentioned minimum width when processing the sensor data in the third step 115 of the method 100, it is advantageously ensured that the correction of the magnetic cogging force 320 as compensation variable 315 by the motor controller 210 is carried out using coefficients that have been determined in the range in which, for example, the movable primary component 227 of the linear motor 225 is currently located.

In the simplest case; i.e. without taking a direction of movement of the primary component 227 of the linear motor 225 into account and/or without taking a current speed of the primary component 227 of the linear motor 225 into account when determining the width or adjusting the width of the compensation interval Δx, a first range of the compensation interval Δx₁=−s and a second range of the compensation interval Δx₂=s must be set so that the total width of the compensation interval Δx is 2·s.

If a direction of movement of the primary component 227 of the linear motor 225 and/or a current speed of the primary component 227 of the linear motor 225 is taken into account when adjusting the width of the compensation interval Δx, the minimum width of the compensation interval is halved. This means that the amount of data generated or the data section of the position-dependent curve of the magnetic cogging force 320 to be considered may be halved, thereby improving the accuracy of the approximation.

When the movable primary component 227 of the linear motor 225 moves in a positive direction, the first range of the compensation interval Δx₁=0 may be set to zero and the second range of the compensation interval Δx₂ may be set to the value s (Δx₂=s). While the movable primary component 227 of the linear motor 225 is at a standstill, the first range of the compensation interval Δx₁ may be set, for example, to −s/2 (Δx₁=−s/2) and the second range of the compensation interval Δx₂ may be set, for example, to s/2 (Δx₂=s/2).

A center xₒₚₜ of the compensation interval may also be chosen more cleverly as:

$${x}_{opt} = x + v \cdot ( {T}_{2} + {T}_{tot} ) .$$

In this context, x corresponds to current sensor data (a current sensor datum); e.g. for the position of the movable primary component 227 of the linear motor 225; e.g. for the current actual position of the movable primary component 227 of the linear motor 225, v indicates the current speed; e.g. of the movable primary component 227 of the linear motor 225, T₂ corresponds to the second cycle time, and Tₜₒₜ denotes a dead time that may occur. The dead time Tₜₒₜ may occur in the system due to the arrangement of the internal processes and may be taken into account according to the above formula.

In general, the minimum width of the compensation interval Δx is smaller than the pole spacing 310. With a pole spacing 310 of, for example, 24 mm, as described above, the minimum width of the approximating data section is in the range of 1/10 of the pole spacing 310. This advantageously leads to low errors in the approximation used, which will be described in more detail below, since the position-dependent course of the magnetic cogging force 320 is essentially determined by the interruption of the stator 260.

The compensation variable 315, which is embodied as a magnetic cogging force 320, may be taken into account for the control of the linear motor 225 as long as the current speed of, for example, the primary component 227 of the motor 225 is below a threshold value. The threshold value specifies a maximum speed; e.g. of the primary component 227 of the linear motor 225, and may vary depending on the motor 220 used. For motors from Beckhoff Automation, the threshold value; i.e. the maximum speed; e.g., of the primary component of the motor, is in a range of vₘₐₓ=300 to 700 mm/s, preferably vₘₐₓ=450 mm/s and particularly preferably; e.g. for linear motors 225 of the type AL8000 from Beckhoff Automation, at vₘₐₓ=500 mm/s. Above the threshold value; i.e., the specified maximum speed, the magnetic cogging force 320 has a minor influence on the movement of the linear motor 225, since, for example, the primary component 227 of the linear motor 225 then moves too quickly and the magnetic cogging force 320 is no longer significantly “noticeable” in the mechanics.

The sensor data and/or the determined coefficients of the compensation function form process data during data exchange via the field bus 245 with the second cycle time T₂, which, for example, are embedded in EtherCAT data packets if the field bus 245 is embodied as an EtherCAT field bus.

The above-mentioned compensation function forms a polynomial function of the nth degree; e.g. a third-degree polynomial function. The coefficients of the compensation function form the coefficients of the polynomial function of the nth degree; e.g. the coefficients of the third-degree polynomial function. The degree of the polynomial function may be designed differently for each sensor data to be processed and/or may be designed differently for each repetition of the first cycle time T₁ and/or the second cycle time T₂.

More detailed information on the compensation function will be explained in connection with FIG. 5.

A fourth step 120 of the method 100 comprises transmitting the processed sensor data from the controller 215 to the motor controller 210 of the linear motor 225 in the second cycle time T₂. A fifth step 125 of the method 100 comprises evaluating the processed sensor data to provide the compensation variable 315; i.e., the magnetic cogging force 320, from the motor controller 210 in the first cycle time T₁ based on the third step 115 and on current sensor data for which the compensation variable 315; i.e., the magnetic cogging force 320, may be determined in the first cycle time T₁ by the motor controller 210. The motor controller 210 is configured in the first cycle time T₁ to carry out the evaluation of the processed sensor data in the fifth step 125 based on the coefficients of the compensation function determined in the second cycle time T₂ and based on current sensor data in the first cycle time T₁, and to determine the compensation variable 315 from this.

It goes without saying that the evaluation of the processed sensor data in the fifth step 125 may include that the coefficients of the compensation function determined in the third step 115, in the second cycle time T₂ are based on sensor data from a previous cycle, compared to the current sensor data that may be received again by the motor controller 210 in the shorter first cycle time T₁, for example. As mentioned above, the second cycle time T₂ may be slower than the first cycle time T₁.

Due to the combination of previously determined coefficients and current sensor data, from which the compensation variable 315 may be determined in the shorter first cycle time T₁, it is advantageous that recorded sensor data does not need to be temporarily stored. Instead, the sensor data recorded during the processing time of the sensor data processed in the previous cycle (processing time referred to as the second cycle time T₂) for the compensation interval may instead be combined directly with newly recorded sensor data, wherein the compensation variable 315 is then determined by the motor controller 210 itself from the newly recorded sensor data using the coefficients of the compensation function. This means that the motor controller 210 inserts the coefficients of the compensation function determined by the controller 215 together with the current sensor data into the compensation function and finally obtains the compensation variable 315.

The fifth step 125 of method 100 may also comprise evaluating the processed sensor data based on the third step 115 and the currently recorded sensor data during the first cycle time T₁ (the results of which, as mentioned above, may be combined with each other) also includes applying the compensation; i.e. the determined coefficients of the compensation function, to the actual control of, for example, the movable primary component 227 of the linear motor 225. It is conceivable that the compensation; i.e. the determination of the coefficients of the compensation function independently; i.e. in parallel with the actual control, by the actual control and that the compensation is then only applied to the control of the linear motor 225; e.g. as an additive quantity, in order to ensure homogeneous movement of, for example, the primary component 227 of the linear motor 225. This advantageously ensures transparency and reduces susceptibility to errors.

It should also be noted that the sensor data and/or the determined coefficients of the compensation function form (control-relevant) process data during data exchange via the field bus 245 with the second cycle time T₂, which are embedded in EtherCAT data packets, in particular if the field bus 245 is embodied as an EtherCAT field bus.

FIG. 4 shows a schematic depiction of the progression of a compensation variable 315, which comprises, for example, a magnetic cogging force 320, as described in the description of FIGS. 1 to 3, and which is corrected in the course of controlling the movable primary component 227 of the linear motor 225, for example. The exemplary curve of the magnetic cogging force 320 (vertical axis) comprising the compensation variable 315 is plotted against the position x (horizontal axis), wherein the position x may correspond, for example, to a sensor data point recorded by the sensor unit 205. The exemplary curve of the compensation variable 315; i.e., the magnetic cogging force 320 in FIG. 4, along the travel distance may be determined for the linear motor 225, for example, with the aid of measurement runs. When the motor moves along the entire travel distance with active position control, the force curve that occurs during this movement along the entire travel distance may be recorded as compensation variable 315.

It goes without saying that the data excerpt has been selected arbitrarily and that the invention is not limited to the depiction. The magnetic cogging force 320 may be specified in the depiction in FIG. 4 by the unit N (Newton), while the position x may be specified by the unit mm. It also goes without saying that if the motor 220 has a different embodiment; e.g. as a rotary motor, the horizontal axis may be specified e.g. as a rotation angle or a rotation angle position; e.g., between 0° and 360°, and the vertical axis may be specified by the unit Nm for the magnetic cogging torque (magnetic cogging torque).

FIG. 4 also shows the pole pitch 310, which is 24 mm for linear motors 225 of the AL8000 type of Beckhoff Automation, for example. Three oscillations are visible within the pole pitch 310, or rather, three oscillations are visible every 24 mm (pole pitch 310). Each oscillation is generated by a single pole tooth or a stator winding or a coil 270 or coil winding. The example curve of the magnetic cogging force 320 in FIG. 4 shows no repetition or periodicity; instead, the curve is individually formed for each position x. This explains the high amount of data mentioned at the beginning, which is required to correct the magnetic cogging force 320 for a linear motor 225.

As described above, a compensation interval is used to correct the magnetic cogging force 320, for which the magnetic cogging force 320 is approximated as a compensation variable 315 with the aid of the compensation function embodied as a polynomial function. The compensation interval for considering, for example, the movable primary component 227 of the linear motor 225 for a direction of movement is preferably selected to be less than or equal to 1/10 of the pole spacing.

FIG. 5 shows an example of the method 100 in FIG. 1 for the automation system 200 in FIG. 2 and its components in FIG. 3. It goes without saying that the above description of FIGS. 1 to 4 also applies without restriction to FIG. 5, even if details are not repeated for reasons of redundancy, and conversely, that the description of FIG. 5 also applies without restriction to the preceding figures. The automation system 200 comprises the motor controller 210, which is embodied, for example, as a servo amplifier, and the controller 215, which is connected to the motor controller 210 via the field bus 245. In FIG. 5, the field bus 245 is embodied, for example, as an EtherCAT field bus, and data communication via the EtherCAT field bus takes place in the form of EtherCAT data packets, which are transmitted cyclically with the second cycle time T₂. The second cycle time T₂ may have a value of 2 ms, while the first cycle time T₁ may be significantly shorter, for example with the above-mentioned value T₁=62.5 μs.

In contrast to the depiction of the automation system 200 in FIG. 2, the motor controller 210 in FIG. 5 comprises a drive control module 325, a pulse width control module 330, and a power electronics module 335 in order to apply the compensation variable 315 (or magnetic cogging force 320) approximated by the method 100 to the actual control, with the aid of the drive control module 325 of the linear motor 225 and implementation of the control by the pulse width modulation module 330 and the power electronics module 335; e.g. as an additive quantity. It goes without saying that the components mentioned may also be part of the motor controller 210 shown in FIG. 2.

In FIG. 5, the compensation function \tilde{F} is approximated, for example, with \tilde{f}(x) in the compensation interval [7−Δx₁, . . . , 7+Δx₂] by the controller 215 in the third step 115 of the method 100, which is schematically indicated in FIG. 5, so that \tilde{F}=\tilde{f}(x) applies with the position, for example, x=7 and \tilde{f}(x)=p₀+p₁x+p₂x²+p₃x³, for example, with coefficients p₀, p₁, p₂, p₃ as a third-degree polynomial function. For example, no direction of movement of the linear motor 225 and no current speed of the linear motor 225 are taken into account for the specified compensation interval. However, this may be carried out without restriction. It is also conceivable to carry out the compensation for a deviating position x as the sensor datum of, for example, the movable primary component 227 of the linear motor 225.

The coefficients p₀, p₁, p₂, p₃ of the compensation function \tilde{F} with the third-degree polynomial function \tilde{f}(x) are transmitted by the controller 215 via the field bus 245; i.e., the EtherCAT field bus, to the motor controller 210—also within the second cycle time T₂.

The motor controller 210 finally executes the fifth step 125 of the method 100, which is shown schematically, namely the evaluation of the processed sensor data; i.e. the evaluation of the determined coefficients p₀, p₁, p₂, p₃.

For this purpose, the motor controller 210 calculates the compensation function \tilde{F} with the determined coefficients p₀, p₁, p₂, p₃ for the current position x of, for example, the movable primary component 227 of the linear motor 225. The fifth step 125, which is schematically indicated and just described, is repeated every 62.5 μs, and the compensation function \tilde{F} or compensation force determined in this way, each comprising at least the magnetic cogging force 320, is fed every 62.5 μs into the drive control module 325 and the other components that are required for controlling; i.e. drive control of, for example, the movable primary component 227 of the linear motor 225. As described above, the sensor unit 205 determines new sensor data every 62.5 μs; i.e., position data of the movably embodied primary component 227 of the linear motor 225.

The approximation of the compensation function \tilde{F} using a third-degree polynomial function \tilde{f}(x) is carried out, for example, according to Javier I. Carrero, “Manual for the polyfit function”, Oct. 5, 2012, using Scilab (www.scilab.org). The maximum polynomial degree n was set to three for the approximation of the compensation function \tilde{F}. If a current data excerpt from the above-mentioned compensation interval yields lower approximation errors with a polynomial degree n less than three, the smaller polynomial degree is used for the approximation and the higher-order coefficients; i.e. the higher-order polynomial coefficients, may be set to zero accordingly. It is also conceivable to use an alternative approximation to that cited in the above reference or to choose a polynomial degree larger than three.

The following describes excerpts from Javier I. Carrero, “Manual for the polyfit function”, Oct. 5, 2012, which may be applied to all of the FIGS. 1 to 5 mentioned for the approximation of the compensation function \tilde{F} using the polynomial function \tilde{f}(x). By using the input command polyfit in Scilab, n coefficients/polynomial coefficients:

$${p}_{n} , … , {p}_{1} , {p}_{0}$$

may be obtained in the form of a vector [pₙ . . . p₁ p₀] for a set m (x, \tilde{f}(x)) of data points for the polynomial function:

$$\tilde{f} ( x ) = {p}_{0} + {p}_{1} x + {p}_{2} {x}^{2} + {p}_{3} {x}^{3} .$$

The determined coefficients/polynomial coefficients pₙ, . . . p₁, p₀ approximate the polynomial function \tilde{f}(x) as closely as possible in such a way that the sum of the residuals

$${( \tilde{f} ( x ) - {\tilde{f}}_{c} ( x ) )}^{2}$$

is minimized, wherein \tilde{f}_{c}(x) comprises the value determined with the aid of the polynomial function:

$$\tilde{f} ( x ) = {p}_{0} + {p}_{1} x + {p}_{2} {x}^{2} + {p}_{3} {x}^{3} .$$

A simple example from Javier I. Carrero, “Manual for the polyfit function”, Oct. 5, 2012, may be applied to the present invention in FIGS. 1 to 5, and, for example, the following numbers may be replaced by alternative numbers; i.e. alternative positions x.

Given the data:

$$\begin{matrix}x\_ 1 st = [ 012345 ] \\ y\_ 1 st = [ 2.1 7.7 13.6 27.2 40.9 61.1 ]\end{matrix}$$

for which a third-degree polynomial function, that best approximates the above data and comprises the following form is to be determined:

$$y = \tilde{f} ( x ) = {p}_{0} + {p}_{1} x + {p}_{2} {x}^{2} + {p}_{3} {x}^{3}$$

The Scilab input command polyfit (x_1st, y_1st, 3) yields:

$$2.2507937 + 3.3994709 x + 1.2912698 {x}^{2} + 0.0759 \; 259 {x}^{3}$$

as a result.

Further details may be found in Javier I. Carrero, “Manual for the polyfit function”, Oct. 5, 2012. It goes without saying that, as described above, the amount of data may be further reduced by cleverly choosing the compensation interval Δx (e.g., by taking into account a direction of movement of the movable primary component 227 of the linear motor 225, etc.), the amount of data may further be reduced. The above numerical example would then be carried out by the controller 215 with real values x (real sensor data x) in order to determine the coefficients pₙ, . . . , p₁, p₀ of the compensation interval Δx. It is conceivable that the motor controller 210 executes the numerical example mentioned for individual real values x; i.e. individual real sensor data x.

The invention has been described in detail by preferred embodiments. Instead of the embodiments described, other embodiments are conceivable which may comprise further modifications or combinations of the features described. For this reason, the invention is not limited by the disclosed embodiments, since other variations may be derived from them by a person skilled in the art without leaving the protective scope of the invention.

TABLE 1
References

100 Method for compensating a compensation torque
105 First step
110 Second step
115 Third step
120 Fourth step
125 Fifth step
200 Automation system
205 Sensor unit
210 Motor controller
215 Controller
220 Motor
225 Linear motor
227 Primary component
229 Secondary component
240 Connecting line
241 First connecting line
243 Third connecting line
245 Field bus
250 Unidirectional data exchange
255 Bidirectional data exchange
260 Plurality of stator segments
265 First stator segment
270 Plurality of spools
275 Coils of the first stator segment
280 Plurality of magnet modules
283 First magnet module
285 Movable
290 Travel path
295 Air gap
300 Magnetic field
305 Active connection
310 Pole spacing
315 Compensation variable
320 Magnetic cogging force
325 Drive control module
330 Pulse width modulation module
335 Power electronics module
Δx Compensation interval
Δx Compensation interval
Δx₂ Second range of compensation interval
T₁ First cycle time
T₂ Second cycle time

What is claimed is:

1. A method for providing a compensation variable for compensating for synchronism fluctuations for a motor, wherein:
the motor comprises a primary component and a secondary component, and
the primary component comprises a plurality of coils configured to be energized to generate a magnetic field in active connection with a plurality of magnet modules of the secondary component,
wherein the primary component is configured to be moveable relative to the secondary component, via the active connection;
wherein the method comprises the following steps:
recording sensor data by a sensor unit in a first cycle time and transmitting the recorded sensor data in the first cycle time to a motor controller in a first step,
transmitting the sensor data from the motor controller to a controller in a second cycle time in a second step, wherein the second cycle time is selectable to have a value different from the first cycle time, or a value larger than the first cycle time,
processing the sensor data by the controller in a third step in the second cycle time, wherein the controller is configured to approximate the compensation variable from the sensor data for a compensation interval,
transmitting the processed sensor data from the controller to the motor controller of the motor in the second cycle time in a fourth step, and
evaluating the processed sensor data to provide the compensation value from the motor controller in a fifth step in the first cycle time based on the third step and on current sensor data, wherein the compensation value is determinable in the first cycle time by the motor controller.

2. The method according to claim 1, wherein:
the controller approximates the compensation variable for the compensation interval in the third step by determining coefficients of a compensation function for the compensation interval from the sensor data in the second cycle time, and
wherein the motor controller is configured to carry out evaluating the processed sensor data in the fifth step based on the coefficients of the compensation function determined in the second cycle time and based on current sensor data, and to determine the compensation value therefrom.

3. The method according to claim 1, wherein:
a minimum width of the compensation interval is determinable from twice a maximum position change of the motor, or from twice a maximum position change of the primary component relative to the secondary component, within the second cycle time, and
wherein the maximum position change for said motor being configured as a linear motor corresponds to a maximum travel distance along a direction of movement of the primary component of the motor, within the second cycle time.

4. The method according to claim 3, wherein:
a direction of movement of the motor, or of the primary component of the motor, and/or a current speed of the motor is taken into account when adjusting a width of the compensation interval, and
wherein, if a direction of movement of the motor, or of the primary component of the motor, and/or the current speed of the motor is or are taken into account when adjusting the width of the compensation interval, the minimum width of the compensation interval is halved.

5. The method according to claim 3, wherein:
the compensation value is taken into account as long as a current speed of the motor, or of the primary component of the motor, is below a threshold value,
wherein the threshold value indicates a maximum speed of the motor, or of the primary component of said linear motor, wherein the maximum speed is in a range from 300 mm/s to 700 mm/s.

6. The method according to claim 2, wherein:
the compensation function forms a polynomial function of an nth degree, or a polynomial function of a third degree,
wherein the coefficients of the compensation function form coefficients of said polynomial function being of the nth degree, or of said polynomial function being of the third degree,
wherein said degree of the polynomial function is different for each sensor data to be processed by the controller, and/or when the first cycle time and/or the second cycle time are repeated.

7. The method according to claim 1, wherein:
data exchange between a sensor unit and the motor controller, and/or energy exchange between the motor controller and the primary component of the motor, via at least one connecting line, takes place with the first cycle time,
wherein data exchange between the motor controller and the controller takes place via a first connecting line with the second cycle time, wherein the first connection line is configured as a field bus, or as an EtherCAT field bus, or
wherein the sensor data and/or the compensation variable approximated for the compensation interval form process data during a data exchange via the field bus with the second cycle time, which process data are embedded in EtherCAT data packets if the field bus is configured as an EtherCAT field bus.

8. The method according to claim 1, wherein:
the motor is configured as a linear motor and the compensation variable comprises at least one magnetic cogging force, or
wherein the motor is configured as a rotary motor and the compensation variable comprises at least one magnetic cogging torque.

9. An automation system comprising:
a sensor unit operatively connected to a motor controller of a motor,
a motor operatively connected to the motor controller, and
a controller operatively connected to the motor controller or integrated into the motor controller;
wherein the sensor unit is configured to record sensor data in a first cycle time and to transmit the recorded sensor data in the first cycle time to the motor controller,
wherein the motor controller is configured to transmit the received sensor data to the controller in a second cycle time, wherein the second cycle time is selectable to have a different value from the first cycle time, or a value larger than the first cycle time,
wherein the controller is configured to process the sensor data in the second cycle time,
wherein processing the sensor data in the second cycle time includes approximating a compensation variable for compensating for synchronism fluctuations for the motor from the sensor data for a compensation interval, and transmitting the processed sensor data in the second cycle time to the motor controller, and
wherein the motor controller is configured to evaluate the processed sensor data in the first cycle time to provide the compensation variable based on the sensor data processed by the controller in the second cycle time and current sensor data, wherein the compensation variable is determinable in the first cycle time by the motor controller.

10. The automation system according to claim 9, wherein:
the controller is configured to approximate the compensation value for a compensation interval by determining coefficients of a compensation function for the compensation interval from the sensor data in the second cycle time, and
wherein the motor controller is configured to evaluate the processed sensor data in the first cycle time based on the coefficients of the compensation function determined in the second cycle time and based on current sensor data, and to determine the compensation value therefrom.

11. The automation system according to claim 9,
wherein the motor comprises a primary component and a secondary component,
wherein, if the motor is configured as a linear motor, the primary component is configured to be movable relative to the secondary component,
wherein the primary component comprises a plurality of coils configured to be energized to generate a magnetic field in active connection with a plurality of magnet modules of the secondary component,
wherein the magnet modules are arranged along a travel path of the motor, and
wherein the primary component is set in motion relative to the secondary component via the active connection.

12. The automation system according to claim 9, wherein:
data exchange between the sensor unit and the motor controller, and/or energy exchange between the motor or the primary component of the motor and the motor controller, via at least one connecting line which is configured as an operational connection, takes place with the first cycle time,
wherein data exchange between the sensor unit and the motor controller takes place via a first connecting line with the second cycle time, wherein the first connecting line between the controller and the motor controller is configured as a field bus, or as an EtherCAT field bus, or
wherein the sensor data and/or the compensation variable approximated for the compensation interval form process data during data exchange via the field bus with the second cycle time, which process data are embedded in EtherCAT data packets if the field bus is configured as an EtherCAT field bus.

13. The automation system according to claim 9, wherein:
a minimum width of the compensation interval is determinable by the controller from twice a maximum position change of the motor, or of the primary component, in relation to the secondary component, within the second cycle time,
wherein the maximum position change corresponds, in the case of said motor being configured as a linear motor, to the maximum travel distance of the motor along a direction of movement of the motor, or of the primary component, within the second cycle time.

14. The automation system according to claim 10, wherein:
the compensation function forms a polynomial function of an nth degree, or a polynomial function of a third degree,
wherein the coefficients of the compensation function form coefficients of said polynomial function being formed of the nth degree, or of said polynomial function being formed of the third degree,
wherein said degree of the polynomial function is different for each sensor data to be processed, and/or when repeating the first cycle time and/or the second cycle time.

15. The automation system according to claim 9, wherein:
the motor is configured as a linear motor and the compensation variable comprises at least one magnetic cogging force,
wherein the linear motor comprises the primary component and the secondary component with the plurality of magnetic modules,
wherein the primary component comprises a plurality of stator segments, each of which has a plurality of energizable coils,
wherein a stator segment of said stator segments defines a pole pitch or period with which a polarity of the plurality of magnet modules of the secondary component repeats, and
wherein a minimum width of the compensation interval is smaller than the pole pitch.

16. The automation system according to claim 9, wherein the motor is configured as a rotary motor and the compensation variable comprises at least one magnetic cogging torque.

17. A method for providing a compensation variable for compensating for synchronism fluctuations for a motor, wherein:
the motor comprises a primary component and a secondary component, and
the primary component comprises a plurality of coils configured to be energized to generate a magnetic field in active connection with a plurality of magnet modules of the secondary component,
wherein the primary component is configured to be moveable relative to the secondary component, via the active connection;
wherein the method comprises the following steps:
recording sensor data by a sensor unit in a first cycle time and transmitting the recorded sensor data in the first cycle time to a motor controller in a first step, wherein the sensor data are actual positions of the primary component of the motor,
transmitting the sensor data from the motor controller to a controller in a second cycle time in a second step, wherein the second cycle time selectable to have a value different from the first cycle time, or a value larger than the first cycle time,
processing the sensor data by the controller in a third step in the second cycle time, wherein the controller is configured to approximate the compensation variable from the sensor data for a compensation interval by determining coefficients of a compensation function for the compensation interval from the sensor data in the second cycle time,
wherein a direction of movement of the primary component of the motor and/or a current speed of the motor is taken into account when adjusting a width of the compensation interval, wherein a minimum width of the compensation interval corresponds to a maximum position change of the primary component with regard to the secondary component within the second cycle time,
transmitting the processed sensor data from the controller to the motor controller of the motor in the second cycle time in a fourth step, and
evaluating the processed sensor data to provide the compensation value from the motor controller in a fifth step in the first cycle time based on the coefficient of the compensation function determined in the second cycle time in the third step and on current sensor data, wherein the compensation value is determinable in the first cycle time by the motor controller.

18. The method according to claim 17, wherein:
the compensation value is taken into account as long as a current speed of the motor, or of the primary component of the motor, is below a threshold value, and
wherein the threshold value indicates a maximum speed of the motor, or of the primary component of a linear motor configuration of said motor, wherein the maximum speed is in a range from 300 mm/s to 700 mm/s.

19. The method according to claim 17, wherein:
the compensation function forms a polynomial function of an nth degree, or a polynomial function of a third degree,
wherein the coefficients of the compensation function form coefficients of said polynomial function being formed of the nth degree, or of said polynomial function being formed of the third degree, and
wherein said degree of the polynomial function is different for each sensor data to be processed, and/or when the first cycle time and/or the second cycle time are repeated.

20. The method according to claim 17, wherein:
data exchange between a sensor unit and the motor controller, and/or energy exchange between the motor controller and the movable primary component of the motor, via at least one connecting line, takes place with the first cycle time,
wherein data exchange between the motor controller and the controller takes place via a first connecting line with the second cycle time, wherein the first connection line is configured as a field bus, or as an EtherCAT field bus, or
wherein the sensor data and/or the compensation variable approximated for the compensation interval form process data during data exchange via the field bus with the second cycle time, which process data are embedded in EtherCAT data packets if the field bus is configured as an EtherCAT field bus.
